(19) United States
(12) Patent Application Publication
(10) Pub. No.: US 2026/0106142 A1
(43) Pub. Date: Apr. 16, 2026

(54) ELECTRICAL ENERGY STORAGE DEVICE AND MANUFACTURING METHOD FOR ELECTRICAL ENERGY STORAGE DEVICE

(71) Applicant: Prime Planet Energy & Solutions, Inc., Tokyo (JP)

(72) Inventors: Naoki SONODA, Kobe-shi (JP); Kentaro TSUKAMOTO, Kobe-shi (JP); Masao FUKUNAGA, Kobe-shi (JP)

(21) Appl. No.: 19/351,303

(22) Filed: Oct. 7, 2025

(30) Foreign Application Priority Data
Oct. 10, 2024 (JP) 2024-177649

(51) Int. Cl. H01M 4/36; H01M 4/02; H01M 4/583; H01M 4/62; H01M 10/0563; H01M 10/0587; H01M 50/618

(52) U.S. Cl. CPC H01M 4/366; H01M 4/583; H01M 4/62; H01M 10/0563; H01M 10/0587; H01M 50/618; H01M 2004/021; H01M 2004/027; H01M 2200/00

(57) ABSTRACT

In an electrical energy storage device disclosed herein, a negative electrode includes a negative electrode active material layer with a length of 200 mm or more in a winding axis direction. A half width ratio (Lh/La) calculated based on a ratio (B/C) of a boron element at a central part of the negative electrode active material layer in the winding axis direction is 0.17 or less.

### CROSS REFERENCE TO RELATED APPLICATION

This application claims the benefit of priority to Japanese Patent Application No. 2024-177649 filed on Oct. 10, 2024. The entire contents of this application are hereby incorporated herein by reference.

### BACKGROUND OF THE DISCLOSURE

### 1. Field

The present disclosure relates to an electrical energy storage device and a manufacturing method for the electrical energy storage device.

### 2. Background

Conventionally, an electrical energy storage device including a wound electrode body in which a positive electrode with a band shape and a negative electrode with a band shape are stacked and wound in an insulated state, and a nonaqueous electrolyte solution has been known (for example, Japanese Patent Application Publication No. 2023-081159).

### SUMMARY

In an electrical energy storage device, a part of a nonaqueous electrolyte solution is decomposed typically at the first charging and a film including a decomposition product thereof (solid electrolyte interface film: SEI film) is formed on a surface of a negative electrode. By this film, an interface between a negative electrode active material layer and the nonaqueous electrolyte solution is stabilized.

In electrical energy storage devices with the capacity increased in recent years, the width of a wound electrode body in a winding axis direction becomes long, making it difficult for a nonaqueous electrolyte solution to permeate into a central part in the winding axis direction. The present inventors' examination indicates that this results in a risk that film formation becomes insufficient at a central part of a negative electrode active material layer and the thermal stability tends to decrease.

The present disclosure has been made in view of the above circumstances, and an object is to provide an electrical energy storage device with excellent thermal stability.

The present disclosure provides an electrical energy storage device including a wound electrode body in which a positive electrode with a band shape and a negative electrode with a band shape are stacked and wound in an insulated state, a nonaqueous electrolyte solution, and a case that accommodates the wound electrode body and the nonaqueous electrolyte solution. The negative electrode includes a negative electrode active material layer containing a carbon material and having a length of 200 mm or more in a winding axis direction, the negative electrode active material layer includes a film containing a boron element, and a ratio (B/C) of the boron element to a carbon element is obtained along the winding axis direction in accordance with laser ablation ICP mass spectrometry at a central part of the negative electrode active material layer in the winding axis direction and a half width ratio calculated by the following procedures is 0.17 or less: (procedure 1) a graph showing a measurement position in the winding axis direction along a horizontal axis and the ratio (B/C) along a vertical axis is created; (procedure 2) a base line connecting both ends of the central part in the winding axis direction is drawn, and based on a width of a straight line extended along the vertical axis to the base line from a peak position at which a value of the ratio (B/C) is the minimum, a half width is measured at a position where the width of the straight line becomes a half; and (procedure 3) the half width is divided by a length of the negative electrode active material layer in the winding axis direction.

As a result of the present inventors' earnest examination, it has been found out that the half width ratio is in correlation with the thermal stability. With the aforementioned structure, the electrical energy storage device with the excellent thermal stability can be achieved.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating an electrical energy storage device according to an embodiment;

FIG. 2 is a schematic longitudinal cross-sectional view taken along line II-II in FIG. 1;

FIG. 3 is a schematic lateral cross-sectional view taken along line III-III in FIG. 1;

FIG. 4 is a perspective view schematically illustrating an electrode body group attached to a sealing plate;

FIG. 5 is a perspective view schematically illustrating a wound electrode body according to the embodiment;

FIG. 6 is a schematic view illustrating a structure of the wound electrode body according to the embodiment;

FIG. 7 is a graph showing a pattern of pressure change in a permeating step;

FIG. 8 is a schematic view of a measurement sample;

FIG. 9 is a graph showing a distribution of a ratio (B/C) in Example 1;

FIG. 10A is a graph showing a distribution of the ratio (B/C) in Comparative Example 1, FIG. 10B is a graph showing a distribution of the ratio (B/C) in Comparative Example 2, FIG. 10C is a graph showing a distribution of the ratio (B/C) in Example 2, FIG. 10D is a graph showing a distribution of the ratio (B/C) in Example 3, and FIG. 10E is a graph showing a distribution of the ratio (B/C) in Comparative Example 3;

FIG. 11 is a graph showing a relation between a first standby time and a half width ratio; and

FIG. 12 is a graph showing a relation between the half width ratio and the amount of heat generation of a negative electrode.

### DETAILED DESCRIPTION OF THE PREFERRED EMBODIMENTS

Hereinafter, some preferred embodiments of the art disclosed herein will be described with reference to the drawings. Note that matters other than matters particularly mentioned in the present specification and necessary for the implementation of the present disclosure (for example, the general configuration and manufacturing process of an electrical energy storage device that do not characterize the present disclosure) can be grasped as design matters of those skilled in the art based on the prior art in the relevant field. The present disclosure can be implemented on the basis of the disclosure of the present specification and common technical knowledge in the relevant field. Note that in the present specification, the notation “A to B” for a range signifies a value more than or equal to A and less than or equal to B, and is meant to encompass also the meaning of being “more than A” and “less than B”.

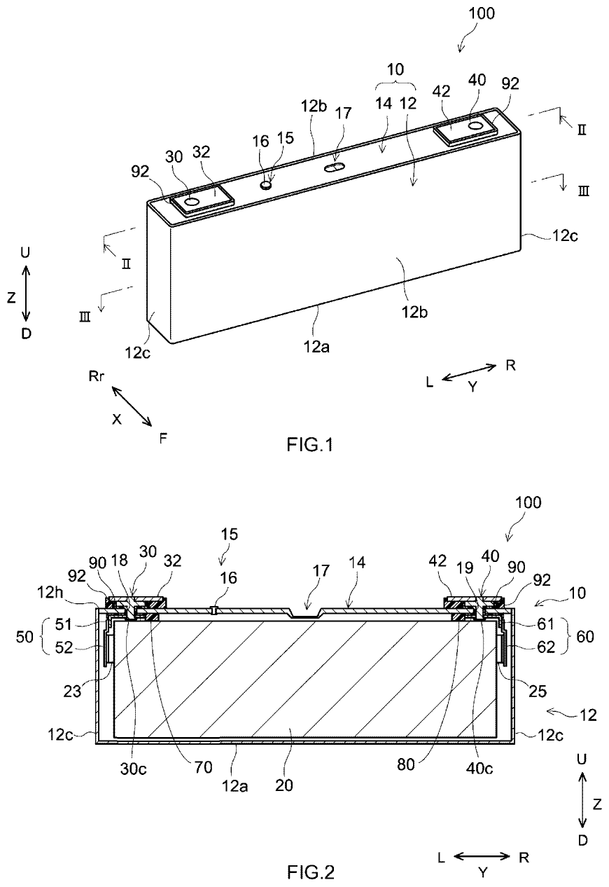

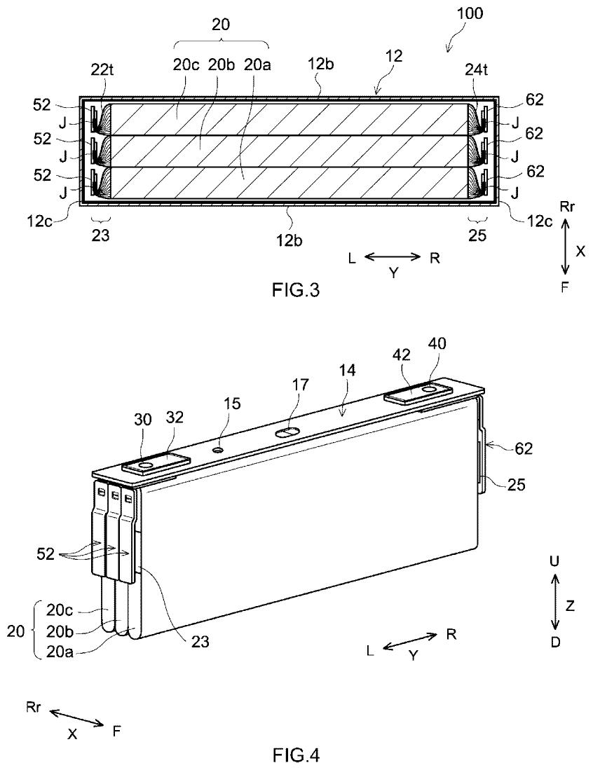

In the present specification, the term “electrical energy storage device” refers to a general electrical energy storage device capable of being repeatedly charged and discharged by transfer of charge carriers between a positive electrode and a negative electrode through a nonaqueous electrolyte solution. The electrical energy storage device refers to a concept that encompasses a so-called secondary battery such as a lithium ion secondary battery or a nickel hydrogen secondary battery, and moreover a capacitor using a chemical reaction, such as a lithium ion capacitor or a pseudo-capacitor.

<Battery 100> FIG. 1 is a perspective view of an electrical energy storage device (hereinafter, also referred to as a battery simply) 100. FIG. 2 is a schematic longitudinal cross-sectional view taken along line II-II in FIG. 1. FIG. 3 is a schematic lateral cross-sectional view taken along line III-III in FIG. 1. In the following description, reference signs L, R, F, Rr, U, and D in the drawings respectively denote left, right, front, rear, up, and down, and reference signs X, Y, and Z in the drawings respectively denote a short side direction of the battery 100, a long side direction that is orthogonal to the short side direction, and an up-down direction that is orthogonal to the short side direction and the long side direction. The long side direction Y is one example of a winding axis direction. These directions are defined however for convenience of explanation, and do not limit the manner in which the battery 100 is disposed.

As illustrated in FIG. 2, the battery 100 includes a case 10, an electrode body group 20, and a nonaqueous electrolyte solution (not illustrated). The battery 100 here further includes a positive electrode terminal 30, a negative electrode terminal 40, a positive electrode current collecting part 50, and a negative electrode current collecting part 60. The battery 100 is a nonaqueous electrolyte solution secondary battery, specifically a lithium ion secondary battery here. The battery 100 is preferably the lithium ion secondary battery.

The case 10 is a housing that accommodates the electrode body group 20 and the nonaqueous electrolyte solution. As illustrated in FIG. 1, the external shape of the case 10 here is a flat and bottomed cuboid shape (rectangular shape). A conventionally used material can be used for the case 10, without particular limitations. The case 10 is preferably made of a metal, and for example, more preferably made of aluminum, an aluminum alloy, iron, an iron alloy, or the like. As illustrated in FIG. 2, the case 10 includes an exterior body 12 having an opening 12h, and a sealing plate (lid body) 14 that covers the opening 12h here.

As illustrated in FIG. 1, the exterior body 12 includes a bottom wall 12a with a substantially rectangular shape, a pair of long side walls 12b extending from long sides of the bottom wall 12a and facing each other, and a pair of short side walls 12c extending from short sides of the bottom wall 12a and facing each other. The bottom wall 12a faces the opening 12h. The long side wall 12b is larger in area than the short side wall 12c. Note that in the present specification, the term “substantially rectangular shape” encompasses, in addition to a perfect rectangular shape (rectangle), for example, a shape whose corner connecting a long side and a short side of the rectangular shape is rounded, a shape whose corner includes a notch, and the like.

As illustrated in FIG. 1, the sealing plate 14 is substantially rectangular in shape in a plan view. As illustrated in FIG. 2, the sealing plate 14 is attached to the exterior body 12 so as to cover the opening 12h of the exterior body 12. The sealing plate 14 faces the bottom wall 12a of the exterior body 12. The case 10 is unified in a manner that the sealing plate 14 is joined (for example, joined by welding) to a periphery of the opening 12h of the exterior body 12. The case 10 is hermetically sealed (closed).

As illustrated in FIG. 2, the sealing plate 14 is provided with a liquid injection hole 15, a gas discharge valve 17, and two terminal extraction holes 18 and 19. The liquid injection hole 15 is a hole for injecting the nonaqueous electrolyte solution after the sealing plate 14 is assembled to the exterior body 12. The sealing plate 14 is preferably provided with the liquid injection hole 15. The liquid injection hole 15 is sealed by a sealing member 16. The gas discharge valve 17 is configured to break when pressure inside the case 10 reaches a predetermined value or more and discharge a gas in the case 10 to the outside. The terminal extraction holes 18 and 19 are formed in both end parts of the sealing plate 14 in the long side direction Y (left end part and right end part in FIG. 2, respectively). The terminal extraction holes 18 and 19 penetrate the sealing plate 14 in a thickness direction (up-down direction Z). The terminal extraction holes 18 and 19 respectively have the inner diameters that enable penetration of the positive electrode terminal 30 and the negative electrode terminal 40 before the electrode terminals are attached to the sealing plate 14 (before a caulking process).

Each of the positive electrode terminal 30 and the negative electrode terminal 40 is fixed to the sealing plate 14 of the case 10. The positive electrode terminal 30 is disposed on one side of the sealing plate 14 in the long side direction Y (left side in FIG. 1 and FIG. 2). The negative electrode terminal 40 is disposed on the other side of the sealing plate 14 in the long side direction Y (right side in FIG. 1 and FIG. 2). As illustrated in FIG. 2, the positive electrode terminal 30 is inserted to the terminal extraction hole 18 and extends to the outside from the inside of the sealing plate 14, and the negative electrode terminal 40 is inserted to the terminal extraction hole 19 and extends to the outside from the inside of the sealing plate 14. The positive electrode terminal 30 and the negative electrode terminal 40 are preferably attached to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 2).

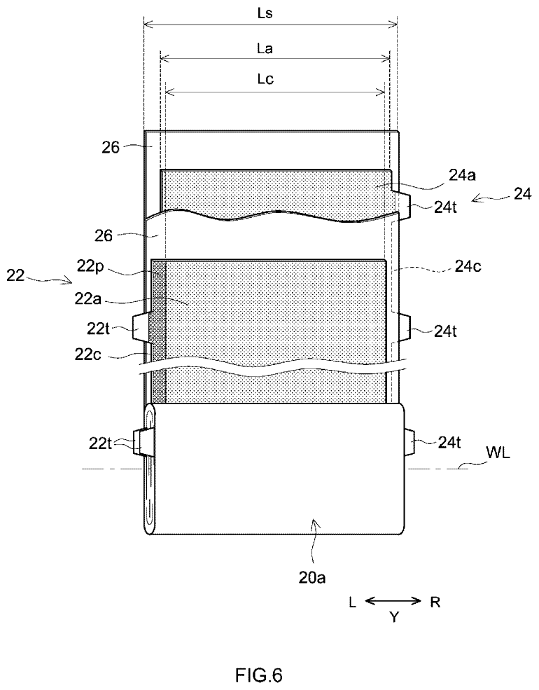

As illustrated in FIG. 2, the positive electrode terminal 30 is electrically connected to a positive electrode 22 (see FIG. 6, in detail, positive electrode tab group 23) of the electrode body group 20 through the positive electrode current collecting part 50 inside the case 10. The positive electrode terminal 30 is insulated from the sealing plate 14 by a positive electrode insulating member 70 and a gasket 90. The positive electrode terminal 30 is preferably formed of a metal and is more preferably formed of, for example, aluminum or an aluminum alloy.

The negative electrode terminal 40 is electrically connected to a negative electrode 24 (see FIG. 6, in detail, negative electrode tab group 25) of the electrode body group 20 through the negative electrode current collecting part 60 inside the case 10. The negative electrode terminal 40 is insulated from the sealing plate 14 by a negative electrode insulating member 80 and the gasket 90. The negative electrode terminal 40 is preferably formed of a metal and is more preferably formed of, for example, copper or a copper alloy. The negative electrode terminal 40 may be configured of two conductive members joined together and integrated. In the negative electrode terminal 40, for example, a part connected to the negative electrode current collecting part 60 may be formed of copper or a copper alloy, and a part exposed on an outer surface of the sealing plate 14 may be formed of aluminum or an aluminum alloy.

A positive electrode external conductive member 32 and a negative electrode external conductive member 42, each having a plate shape, are attached to the outer surface of the sealing plate 14. The positive electrode external conductive member 32 and the negative electrode external conductive member 42 are members to which a busbar is attached when a plurality of the batteries 100 are electrically connected to each other. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are insulated from the sealing plate 14 by an external resin member 92. The positive electrode external conductive member 32 and the negative electrode external conductive member 42 are preferably formed of a metal and are more preferably formed of, for example, aluminum or an aluminum alloy. However, the positive electrode external conductive member 32 and the negative electrode external conductive member 42 are not always necessary and can be omitted in another embodiment.

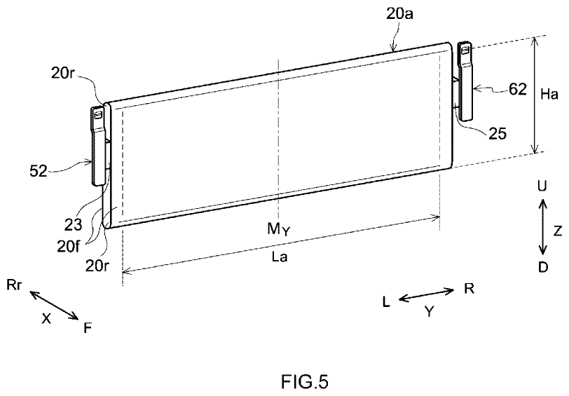

As illustrated in FIG. 2, the electrode body group 20 is accommodated inside the case 10 (in detail, inside the exterior body 12). FIG. 4 is a perspective view schematically illustrating the electrode body group 20 attached to the sealing plate 14. The electrode body group 20 here includes three electrode bodies 20a, 20b, and 20c. In the case where three electrode bodies 20a, 20b, and 20c or more are disposed inside one case 10, it may be difficult for the nonaqueous electrolyte solution in particular to permeate into the electrode body 20b that exists at a central part in the short side direction X. Thus, it is particularly effective to apply the art disclosed herein. The number of wound electrode bodies to be disposed in one case 10 is, however, not limited in particular and may be one, or two or more (plural).

The electrode body group 20 may be disposed inside the case 10 in a state of being covered with an electrode body holder with an insulating property. In other words, the electrode body holder may exist between the electrode body group 20 and the case 10 (in detail, exterior body 12). The electrode body holder is preferably made of resin.

FIG. 5 is a perspective view schematically illustrating the electrode body 20a. FIG. 6 is a schematic view illustrating a structure of the electrode body 20a. Although detailed description will be given below with the electrode body 20a as an example, the electrode bodies 20b and 20c can also be configured in the similar manner. As illustrated in FIG. 6, the electrode body 20a is a wound electrode body in which the positive electrode 22 with a band shape and the negative electrode 24 with a band shape are stacked in an insulated state (for example, through the separator 26 with a band shape) and wound using a winding axis WL as a center.

If the electrode body 20a is the wound electrode body, the nonaqueous electrolyte solution is supplied only from both end parts in a winding axis WL direction. Therefore, it becomes particularly difficult for the nonaqueous electrolyte solution to permeate into a central part of the electrode body 20a in the winding axis WL direction and the film formation amount in the central part tends to be deficient. Thus, it is effective to apply the art disclosed herein.

Although not limited in particular, the number of winding turns (the number of turns) of the electrode body 20a is preferably 20 turns or more, more preferably 30 turns or more, and for example 50 turns or more, and may be 150 turns or less and 100 turns or less, for example. As the number of winding turns increases, it becomes difficult for the nonaqueous electrolyte solution to permeate particularly into the central part of the electrode body 20a (the central part in the short side direction X and the central part in the long side direction Y). Thus, it is particularly effective to apply the art disclosed herein.

As illustrated in FIG. 2 and FIG. 6, the electrode body 20a here is disposed inside the case 10 in a direction along the bottom wall 12a (in other words, a direction in which the winding axis WL is substantially parallel to the long side direction Y). The winding axis WL direction is a direction that coincides with the long side direction Y here. The electrode body 20a is disposed inside the case 10 in a direction in which the winding axis WL is parallel to the bottom wall 12a and orthogonal to the short side wall 12c. A pair of both end surfaces (opening ends) of the electrode body 20a in the winding axis WL direction face the pair of short side walls 12c of the exterior body 12. Both end surfaces of the electrode body 20a in the winding axis WL direction each correspond to an inlet into which the nonaqueous electrolyte solution flows. In such a case, it is particularly effective to apply the art disclosed herein.

The battery 100 here has a so-called lateral tab structure in which the positive electrode tab group 23 and the negative electrode tab group 25 exist on both ends of the electrode body 20a in the winding axis WL direction (left and right in FIG. 2 and FIG. 4). In another embodiment, however, the battery 100 may have a so-called upper tab structure in which the positive electrode tab group 23 and the negative electrode tab group 25 exist on one end of the electrode body 20a in the winding axis WL direction (for example, upper end in FIG. 2 and FIG. 4). In this case, the winding axis WL direction may be a direction that coincides with the up-down direction Z.

As illustrated in FIG. 5, the external shape of the electrode body 20a is a flat shape. The external shape of the electrode body 20a is preferably a flat shape. The electrode body 20a includes a pair of flat parts 20f expanding along the long side direction Y (the winding axis WL direction), and a pair of curved parts (rounded parts) 20r coupling the pair of flat parts 20f. The flat part 20f includes a flat outer surface (YZ plane in FIG. 5). The curved part 20r includes a curved outer surface. Note that in the present specification, “flat outer surface” is not limited to a perfectly flat surface, and is a term that encompasses a case in which a small step, curve, concave part, convex part, or the like is included when viewed microscopically, for example.

As illustrated in FIG. 2 and FIG. 5, the pair of flat parts 20f face the pair of long side walls 12b of the exterior body 12 in this embodiment. The flat part 20f extends along the long side wall 12b. The pair of curved parts 20r face the bottom wall 12a of the exterior body 12 and the sealing plate 14. The electrode body 20a is preferably disposed inside the case 10 in a manner that the stacking direction (thickness direction) of the positive electrode 22 (see FIG. 6) and the negative electrode 24 (see FIG. 6) in the flat part 20f coincides with the short side direction X (direction perpendicular to the long side wall 12b), as described in this embodiment.

The positive electrode 22 may be similar to the conventional positive electrode, without particular limitations. As illustrated in FIG. 6, the positive electrode 22 includes a positive electrode current collector 22c, and a positive electrode active material layer 22a and a positive electrode protection layer 22p that are fixed on at least one surface of the positive electrode current collector 22c. However, the positive electrode protection layer 22p is not essential, and can be omitted in another embodiment. The positive electrode current collector 22c has a band shape. The positive electrode current collector 22c is formed of, for example, a conductive metal such as aluminum, an aluminum alloy, nickel, or stainless steel. Here, the positive electrode current collector 22c is a metal foil, specifically an aluminum foil.

At one end part (left end part in FIG. 6) of the positive electrode current collector 22c in the long side direction Y (the winding axis WL direction), a plurality of positive electrode tabs 22t are provided. Each of the plurality of positive electrode tabs 22t has a convex shape and protrudes toward one side in the long side direction Y (left side in FIG. 6). The plurality of positive electrode tabs 22t extend in the long side direction Y relative to the separator 26. The positive electrode tabs 22t are provided with a space (intermittently) along a longitudinal direction of the positive electrode 22. By providing the plurality of positive electrode tabs 22t, the resistance of the battery 100 can be reduced. The positive electrode tab 22t constitutes a part of the positive electrode current collector 22c here, and is made of a metal foil (aluminum foil).

As illustrated in FIG. 3, the plurality of positive electrode tabs 22t are stacked at one end part in the long side direction Y (left end part in FIG. 3), and form the positive electrode tab group 23. In this embodiment, the plurality of positive electrode tabs 22t are stacked, and bent and curved such that outer ends thereof are aligned. Thus, the accommodating property into the case 10 can be improved and the battery 100 can be reduced in size. In addition, the volume energy density of the battery 100 can be improved. A positive electrode second current collecting part 52 of the positive electrode current collecting part 50 to be described below is attached (in detail, joined) to the positive electrode tab group 23. The plurality of positive electrode tabs 22t are connected to the positive electrode second current collecting part 52 in a state of being stacked and bent here. The positive electrode tab group 23 is electrically connected to the positive electrode terminal 30 through the positive electrode current collecting part 50.

As illustrated in FIG. 6, the positive electrode active material layer 22a is provided to have a band shape along a longitudinal direction of the positive electrode current collector 22c with a band shape. The positive electrode active material layer 22a contains a positive electrode active material (for example, a lithium transition metal complex oxide such as a lithium nickel cobalt manganese containing complex oxide) capable of reversibly storing and releasing the charge carriers. The positive electrode active material layer 22a may contain any component other than the positive electrode active material, for example, a conductive material, a binder, various additive components, or the like. As the conductive material, for example, a carbon material such as acetylene black (AB) can be used. As the binder, for example, polyvinylidene fluoride (PVdF) or the like can be used.

In the battery 100 of a high-capacity type, which is used for vehicles or the like, as illustrated in FIG. 6, a length Lc (average value, excluding a part formed in the positive electrode tab 22t) of the positive electrode active material layer 22a in the long side direction Y (winding axis WL direction) is preferably 150 mm or more, more preferably 200 mm or more, and still more preferably 250 mm or more. The length Lc is preferably less than or equal to a length La of a negative electrode active material layer 24a in the long side direction Y to be described below.

The positive electrode protection layer 22p is provided between the positive electrode current collector 22c and the positive electrode active material layer 22a in the long side direction Y as illustrated in FIG. 6. Here, the positive electrode protection layer 22p is provided at one end part (left end part in FIG. 6) of the positive electrode current collector 22c in the long side direction Y. The positive electrode protection layer 22p is formed to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components. The conductive material and the binder may be the same as those described as the examples that may be contained in the positive electrode active material layer 22a.

As illustrated in FIG. 6, the negative electrode 24 includes a negative electrode current collector 24c and the negative electrode active material layer 24a that is fixed on at least one surface of the negative electrode current collector 24c. The negative electrode current collector 24c has a band shape. The negative electrode current collector 24c is formed of, for example, a conductive metal such as copper, a copper alloy, nickel, or stainless steel. The negative electrode current collector 24c preferably includes copper or a copper alloy. Here, the negative electrode current collector 24c is a metal foil, specifically a copper foil.

At one end part (right end part in FIG. 6) of the negative electrode current collector 24c in the long side direction Y (the winding axis WL direction), a plurality of negative electrode tabs 24t are provided. Each of the plurality of negative electrode tabs 24t has a convex shape and protrudes toward one side in the long side direction Y (right side in FIG. 6). The plurality of negative electrode tabs 24t extend in the long side direction Y relative to the separator 26. The plurality of negative electrode tabs 24t are provided with a space (intermittently) along a longitudinal direction of the negative electrode 24. By providing the plurality of negative electrode tabs 24t, the resistance of the battery 100 can be reduced. The negative electrode tab 24t here constitutes a part of the negative electrode current collector 24c and is made of a metal foil (copper foil). At least a part of the negative electrode tab 24t is a current collector exposing part in which the negative electrode active material layer 24a is not formed and the negative electrode current collector 24c is exposed.

As illustrated in FIG. 3, the plurality of negative electrode tabs 24t are stacked at one end part in the long side direction Y (right end part in FIG. 3) and form the negative electrode tab group 25. In this embodiment, the plurality of negative electrode tabs 24t are stacked, and bent and curved such that outer ends thereof are aligned. Thus, the accommodating property into the case 10 can be improved and the battery 100 can be reduced in size. In addition, the volume energy density of the battery 100 can be improved. A negative electrode second current collecting part 62 of the negative electrode current collecting part 60 to be described below is attached (specifically, joined) to the negative electrode tab group 25. The plurality of negative electrode tabs 24t are connected to the negative electrode second current collecting part 62 in a state of being stacked and bent here. The negative electrode tab group 25 is electrically connected to the negative electrode terminal 40 through the negative electrode current collecting part 60.

As illustrated in FIG. 6, the negative electrode active material layer 24a is provided to have a band shape along the longitudinal direction of the negative electrode current collector 24c with a band shape. The negative electrode active material layer 24a contains a negative electrode active material (for example, a carbon material such as graphite or a silicon material containing silicon) capable of reversibly storing and releasing the charge carriers. The negative electrode active material layer 24a includes a carbon material necessarily. The carbon material can be included as the negative electrode active material typically. When a total solid content of the negative electrode active material layer 24a is set to 100 mass %, the negative electrode active material (for example, graphite or the carbon material) may occupy approximately 80 mass % or more, typically 90 mass % or more, and for example 95 mass % or more. The negative electrode active material layer 24a may contain any component other than the negative electrode active material, for example, a binder, a dispersant, various additive components, or the like. As the binder, for example, rubbers such as styrene-butadiene rubber (SBR) can be used. As the dispersant, for example, celluloses such as carboxymethyl cellulose (CMC) can be used.

As illustrated in FIG. 6, the length La (average value, excluding a part formed in the negative electrode tab 24t) of the negative electrode active material layer 24a in the long side direction Y (winding axis WL direction) is typically more than or equal to the length Lc of the positive electrode active material layer 22a in the long side direction Y. In this embodiment, the length La of the negative electrode active material layer 24a is 200 mm or more from the viewpoints of increasing the capacity, and the like. The length La is preferably 250 mm or more. In the electrode body 20a, as the length La is longer, the nonaqueous electrolyte solution permeates less easily into the central part including a center My (see FIG. 5) in the long side direction Y. As a result, in the central part in the long side direction Y, the film formation amount tends to be deficient. Thus, it is effective to apply the art disclosed herein. The length La may be, for example, 1000 mm or less and 500 mm or less. Thus, the effect of the art disclosed herein can be achieved at a high level.

As illustrated in FIG. 5, a height Ha of the negative electrode active material layer 24a existing in the flat part 20f of the electrode body 20a (the height Ha is the same as the height of the flat part 20f) is preferably 110 mm or less, more preferably 50 to 110 mm, still more preferably 70 to 100 mm, and particularly preferably 70 to 90 mm. In the flat part 20f, a ratio (horizontal/vertical ratio) of the length La of the negative electrode active material layer 24a in the long side direction Y to the height Ha of the negative electrode active material layer 24a is preferably 1 to 10, more preferably 2 to 7, and still more preferably 3 to 5. Thus, the effect of the art disclosed herein can be achieved at the high level.

The negative electrode active material layer 24a includes a film (SEI film) containing a boron (B) element. This boron is a component derived from a compound containing the boron element (B element containing compound) that is added to the nonaqueous electrolyte solution when the battery 100 is constructed, for example, a film formation agent to be described below. The film is, for example, a decomposition product including the B element containing compound that is decomposed at the first charging, which will be described below. Since the film containing the boron element has excellent stability, the durability and the thermal stability of the battery 100 can be improved suitably.

As illustrated in FIG. 6, the separator 26 is a member that insulates the positive electrode active material layer 22a of the positive electrode 22 and the negative electrode active material layer 24a of the negative electrode 24 from each other. A length Ls of the separator 26 in the long side direction Y (winding axis WL direction) is typically more than or equal to the length La of the negative electrode active material layer 24a in the long side direction Y. The separator 26 is preferably, for example, a porous sheet made of resin including polyolefin resin such as polyethylene (PE) or polypropylene (PP). The separator 26 may include a functional layer such as an adhesive layer or a heat resistance layer (HRL) on a surface of a base material part formed by a porous sheet made of resin. The adhesive layer is a layer including a binder. For example, the heat resistance layer is a layer including inorganic filler such as alumina, silica, boehmite, magnesia, or titania and a binder such as PVdF. The heat resistance layer can also serve as the adhesive layer. The structures of the heat resistance layer and the adhesive layer may be similar to the conventional structures thereof.

As illustrated in FIG. 2, the positive electrode current collecting part 50 forms a conductive path for electrically connecting the positive electrode terminal 30 and the positive electrode tab group 23 formed by the plurality of positive electrode tabs 22t. The positive electrode current collecting part 50 may be formed of the same metal species as the positive electrode current collector 22c, for example, a conductive metal such as aluminum, an aluminum alloy, nickel, or stainless steel. The positive electrode current collecting part 50 includes a positive electrode first current collecting part 51 that is connected to the positive electrode terminal 30 and the positive electrode second current collecting part 52 that is connected to the positive electrode tab group 23. The positive electrode first current collecting part 51 is attached to an inner surface of the sealing plate 14.

The positive electrode second current collecting part 52 extends along the short side wall 12c of the exterior body 12. The positive electrode second current collecting part 52 is attached to the positive electrode tab group 23 of the electrode body 20a. As illustrated in FIG. 3, a joining part J with the positive electrode tab group 23 is formed in the positive electrode second current collecting part 52. The joining part J is a welding joining part formed by welding, such as ultrasonic welding, resistance welding, or laser welding, with the plurality of positive electrode tabs 22t stacked on each other, for example. The joining part J is disposed with the plurality of positive electrode tabs 22t placed on one side of the electrode bodies 20a, 20b, and 20c in the short side direction X (front side in FIG. 3). Thus, the plurality of positive electrode tabs 22t can be bent suitably in the stacked state and the positive electrode tab group 23 with the curved shape can be formed stably.

As illustrated in FIG. 2, the negative electrode current collecting part 60 forms a conductive path for electrically connecting the negative electrode terminal 40 and the negative electrode tab group 25 formed by the plurality of negative electrode tabs 24t. The negative electrode current collecting part 60 may be formed of the same metal species as the negative electrode current collector 24c, for example, a conductive metal such as copper, a copper alloy, nickel, or stainless steel. The negative electrode current collecting part 60 includes a negative electrode first current collecting part 61 that is connected to the negative electrode terminal 40 and the negative electrode second current collecting part 62 that is connected to the negative electrode tab group 25. The structure and arrangement of the negative electrode first current collecting part 61 and the negative electrode second current collecting part 62 may be similar to those of the positive electrode first current collecting part 51 and the positive electrode second current collecting part 52 of the positive electrode current collecting part 50, respectively.

The negative electrode second current collecting part 62 is attached to the negative electrode tab group 25 of the electrode body 20a. As illustrated in FIG. 3, the joining part J with the negative electrode tab group 25 is formed in the negative electrode second current collecting part 62. The joining part J is a welding joining part formed by welding, such as ultrasonic welding, resistance welding, or laser welding, with the plurality of negative electrode tabs 24t stacked on each other, for example, similarly to that on the positive electrode side. The joining part J is disposed with the plurality of negative electrode tabs 24t placed on one side of the electrode bodies 20a, 20b, and 20c in the short side direction X (front side in FIG. 3). Thus, the plurality of negative electrode tabs 24t can be bent suitably in the stacked state and the negative electrode tab group 25 with the curved shape can be formed stably.

The nonaqueous electrolyte solution typically contains a nonaqueous solvent and an electrolyte salt (supporting salt). As the nonaqueous solvent, one kind or two or more kinds of nonaqueous solvents that have conventionally been known as being usable for the electrical energy storage device can be used. Examples of the nonaqueous solvent include organic solvents such as carbonates, ethers, esters, nitriles, sulfones, and lactones. The nonaqueous solvent preferably includes the carbonates. Examples of the carbonates include chain carbonates such as ethylene carbonate (EC), dimethyl carbonate (DMC), diethyl carbonate (DEC), and ethyl methyl carbonate (EMC) and cyclic carbonates such as propylene carbonate (PC).

The electrolyte salt is not limited to a particular type as long as the charge carriers (typically, lithium ion) are included, and one kind or two or more kinds of electrolyte salts that have conventionally been known as being usable for the electrical energy storage device can be used. Examples of the electrolyte salt include fluorine-containing lithium salt such as LiPF₆ or LiBF₄, and fluorine-containing sodium salt such as NaPF₆. The electrolyte salt preferably contains LiPF₆.

The nonaqueous electrolyte solution may further contain an additional component (additive). As the additive, one kind or two or more kinds of additives that have conventionally been known as being able to be added to the nonaqueous electrolyte solution can be used. Examples of the additive include: a boron-based additive containing a boron element, such as lithium bisoxalate borate (LiBOB) or lithium difluoro (oxalato) borate (LiODFB); a phosphorus-based additive containing a phosphorus element, such as lithium difluorophosphate (LiPO₂F₂) or lithium difluorooxalate phosphate (LiDFOP); and the like. These additives may be so-called film formation agents that are decomposed before (at lower potential than) the nonaqueous solvent and/or the electrolyte salt at the first charging and deposited as the film on the surface of the negative electrode active material layer 24a.

The nonaqueous electrolyte solution preferably includes the compound containing the boron (B) element (B element containing compound), for example a lithium salt containing the boron element (B element containing lithium salt). Examples of the B element containing compound (for example, B element containing lithium salt) include LiBF₄ given above as the example of the supporting salt, and an oxalato complex compound containing the boron element (B element containing oxalato compound) such as LiBOB or LiODFB given above as the example of the boron-based additive.

The additive that is added into the nonaqueous electrolyte solution at the manufacture (for example, the boron-based additive described above) is decomposed electrically by the first charging or the like and consumed to form the film on the negative electrode active material layer 24a or the like. Therefore, in the state of the battery 100, the additive as described above may be included (remain) or may not be included in the nonaqueous electrolyte solution.

Incidentally, the present inventors' examination indicates that, in the electrode body 20a, the length (width) of the negative electrode active material layer 24a in the long side direction Y (the winding axis WL direction) is 200 mm or more, which is longer than the conventional one, for the purpose of increasing the capacity, for example. Accordingly, the nonaqueous electrolyte solution does not easily permeate into the central part in the long side direction Y. The present inventors' examination indicates that this causes the film formation to be insufficient in the central part of the negative electrode active material layer 24a in the long side direction Y, which may result in the reduction of thermal stability.

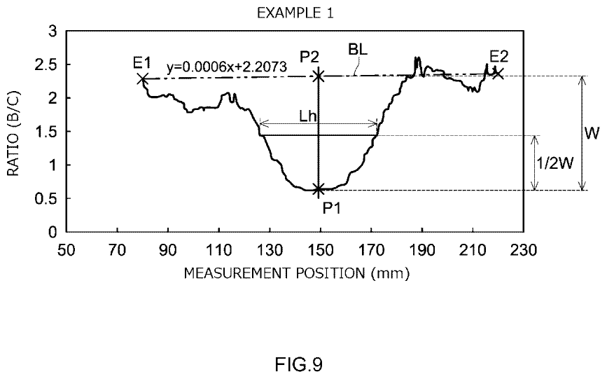

In view of this, in the art disclosed herein, the amount of carbon element and the amount of boron element are measured along the winding axis WL direction in accordance with laser ablation inductively coupled plasma mass spectrometry (LA-ICP-MS) at the central part of the negative electrode active material layer 24a in the winding axis WL direction, a ratio (B/C) of the boron element to the carbon element is obtained, and a half width ratio (Lh/La) calculated below is set to 0.17 or less. For example, the half width ratio (Lh/La) is obtained as described with reference to FIG. 9 below (Test Example) in accordance with the following procedures: (procedure 1) a graph showing a measurement position in the winding axis WL direction along a horizontal axis and the ratio (B/C) along a vertical axis is created; (procedure 2) a base line BL connecting both ends (E1, E2) of the central part of the negative electrode active material layer 24a in the winding axis WL direction is drawn, and based on a width W of a straight line extended along the vertical axis to the base line BL from a peak position P1 at which a value of the ratio (B/C) is the minimum, a half width Lh (mm) along the horizontal axis is measured at a position where the width W of the straight line becomes a half (½W); and (procedure 3) the half width Lh (mm) is divided by the length La (mm) of the negative electrode active material layer 24a in the winding axis WL direction.

According to the present inventors' examination, the half width ratio (or the half width Lh) is correlated with the amount of heat generation, which will be described in detail in Example below. Specifically, the amount of heat generation is suppressed as the value of the half width ratio is smaller. Thus, setting the value of the half width ratio to be less than or equal to a predetermined value makes it possible to provide the battery 100 with excellent thermal stability. In addition, the time required for the nonaqueous electrolyte solution to permeate can also be reduced.

Note that, in this specification, “the central part of the negative electrode active material layer in the winding axis direction” refers to the range including a center My of the negative electrode active material layer 24a in the winding axis WL direction (see FIG. 5) and corresponding to about 49% (an error of about ±1% is allowed) of the length La (mm) of the entire negative electrode active material layer 24a in the winding axis WL direction using the center My as a reference (center). For example, in a case where the length La (mm) is 286 mm, “the central part of the negative electrode active material layer in the winding axis direction” refers to the range of about +70 mm (about 140 mm in total) from the center My in the winding axis WL direction (long side direction Y).

The half width ratio (Lh/La) is preferably 0.16 or less, more preferably 0.15 or less, and still more preferably 0.13 or less from the viewpoint of achieving the effect of the art disclosed herein at a high level. The half width ratio (Lh/La) is preferably 0.05 or more and more preferably 0.1 or more from the viewpoint of suppressing the resistance and the viewpoint of improving the working efficiency or the productivity.

Note that the half width ratio (or the half width Lh) can be adjusted suitably in accordance with not just the amount of liquid injection of the nonaqueous electrolyte solution and the concentration of the additive (the compound containing the boron element) in the nonaqueous electrolyte solution when the battery 100 is constructed but also a condition in a permeating step (step 2) in a manufacturing method to be described below, particularly the standby time until the pressurization is started, the pressurizing condition, or the like.

### <Manufacturing Method for Battery 100>

For example, the battery 100 as described above can be manufactured by a manufacturing method including the following steps in the following order: a constructing step for a battery assembly (step 1), the permeating step (step 2), and a first charging step (step 3). However, another step may be included at an optional stage. For example, the first charging step (step 3) may be followed by a conventionally known aging step (step 4). In the constructing step (step 1), the electrode body group 20 (the electrode bodies 20a, 20b, and 20c) is accommodated in the case 10 and the nonaqueous electrolyte solution is injected; thus, a battery assembly is constructed. In this specification, the term “battery assembly” refers to an intermediate object assembled up to the state before the first charging step (step 3) is performed in the manufacturing process for the battery 100.

In a preferred embodiment, the present step includes a disposing step (step 1-1), a welding joining step (step 1-2), a drying step (step 1-3), and a liquid injecting step (step 1-4) typically in this order. However, the drying step (step 1-3) is optional and can be omitted in another embodiment. In still another embodiment, the order of the welding joining step (step 1-2) and the drying step (step 1-3) may be opposite. Additionally, another step may be included at an optional stage.

In the disposing step (step 1-1), the electrode body group 20 is disposed inside the exterior body 12. In this embodiment, first, a united object in which the sealing plate 14 and the electrode body group 20 are united is manufactured as illustrated in FIG. 4, for example. Next, the electrode body group 20 is accommodated inside the exterior body 12 in such a way that the sealing plate 14 is fitted to the opening 12h of the exterior body 12. Thus, the electrode bodies 20a, 20b, and 20c are accommodated inside the exterior body 12 with the winding axis WL extending along the bottom wall 12a. Next, in the welding joining step (step 1-2), the sealing plate 14 is welded at the periphery of the opening 12h of the exterior body 12 to integrate the exterior body 12 and the sealing plate 14.

Then, in the drying step (step 1-3), the exterior body 12 accommodating the electrode body group 20 is dried with the liquid injection hole 15 opened, so that the moisture inside the exterior body 12 is removed. In particular, the moisture inside the electrode body group 20 is removed. The moisture is removed similarly to the conventional art using a heating and drying device, a vacuum drying device, or the like through operations of heating, depressurization, and the like carried out alone or in combination. The heating temperature is preferably set so that the moisture can be evaporated suitably in a depressurized state and the separator 26 of the electrode body group 20 and the like do not thermally deteriorate, for example. The heating temperature is preferably set in the range of, for example, 50 to 200° C.

Next, in the liquid injecting step (step 1-4), first, the nonaqueous electrolyte solution is prepared. The nonaqueous electrolyte solution includes the B element containing compound (for example, B element containing lithium salt) as described above. In one example, the nonaqueous electrolyte solution preferably includes the boron-based additive in addition to the nonaqueous solvent and the electrolyte salt. Although not limited in particular, the concentration of the boron-based additive in the nonaqueous electrolyte solution is preferably 0.01 mol/L or more and more preferably 0.05 mol/L or more because the film in suitable quantity and/or quality is easily formed on the negative electrode active material layer 24a. On the other hand, from the viewpoint of suppressing the increase in battery resistance, the concentration of the boron-based additive in the nonaqueous electrolyte solution is preferably 1 mol/L or less, more preferably 0.5 mol/L or less, and still more preferably 0.1 mol/L or less.

Then, a predetermined amount of nonaqueous electrolyte solution is injected into the case 10 through the liquid injection hole 15 of the sealing plate 14. The liquid may be injected in the atmospheric pressure state or with the inside of the case 10 depressurized relative to the atmospheric pressure in order to improve the permeation of the nonaqueous electrolyte solution into the electrode body group 20 (the electrode bodies 20a, 20b, and 20c), for example. In addition, the predetermined amount of nonaqueous electrolyte solution may be injected entirely at one time or in multiple stages, that is, N times (N is an integer of 2 or more) separately.

In some embodiments, it is preferable to inject the predetermined amount of nonaqueous electrolyte solution N times (N≥2) separately. Thus, the nonaqueous electrolyte solution easily permeates into the electrode body group 20, particularly into the central part in the long side direction Y (winding axis WL direction). Although there is no particular limitation, the number of times N of liquid injection is preferably 5 or less (N≤5), more preferably 3 or less (N=2 or 3), and still more preferably 2 (N=2) from the viewpoint of improving the working efficiency or the productivity.

In the case where the predetermined amount of nonaqueous electrolyte solution is injected N times (N≥2) separately, it is preferable to provide a certain rest period between a first liquid injection and a second liquid injection. Providing the rest period allows the nonaqueous electrolyte solution to permeate into the electrode bodies 20a, 20b, and 20c suitably; therefore, the liquid surface of the nonaqueous electrolyte solution lowers and in the liquid injection after the rest (in the second liquid injection), more nonaqueous electrolyte solution can be injected. In some embodiments, it is preferable that operations such as pressurization and depressurization be not included between the first liquid injection and the second liquid injection.

The amount of liquid injection (“the predetermined amount” described above) of the nonaqueous electrolyte solution is preferably the amount by which a surplus electrolyte solution is secured between the case 10 and the electrode bodies 20a, 20b, and 20c. In some embodiments, a ratio (Vl/Va) of a volume Vl of the amount of liquid injection of the nonaqueous electrolyte solution to an internal capacity Va of the case 10 is preferably about 0.2 to 0.4 and more preferably 0.25 to 0.3. For example, in the case where the length La of the negative electrode active material layer 24a in the long side direction Y is 200 mm or more (preferably, 250 mm or more), the amount of liquid injection (the predetermined amount) of the nonaqueous electrolyte solution can be about 200 to 600 g, for example 300 to 500 g, or 400 to 450 g.

In a preferred embodiment, 50±10% (40 to 60%) of the predetermined amount is injected in the first liquid injection and after three hours or more from the first liquid injection, the second liquid injection is performed. Thus, even if the length La of the negative electrode active material layer 24a in the long side direction Y is 200 mm or more (preferably, 250 mm or more), the nonaqueous electrolyte solution can permeate thoroughly into the electrode body group 20, particularly to the central part in the long side direction Y (the winding axis WL direction). The amount of liquid injection in the first time is more preferably 50% or more (for example, 50 to 60%) of the predetermined amount. In addition, the timing of the second liquid injection is preferably within five hours from the first liquid injection, and more preferably after three to four hours from the first liquid injection, for example, from the viewpoint of the productivity or the working efficiency.

In some embodiments, the permeating step (particularly, pressurizing operation or depressurizing operation) is preferably performed after the predetermined amount of nonaqueous electrolyte solution is injected entirely. In other words, it is preferable that the liquid injection of the nonaqueous electrolyte solution be not performed after the permeating step. Thus, a sufficient amount of nonaqueous electrolyte solution can exist within the case 10 from the beginning of the permeating step.

In the permeating step (step 2), after the constructing step (specifically, the liquid injecting step), at least the inside of the case 10 is pressurized to make the nonaqueous electrolyte solution permeate into the electrode bodies 20a, 20b, and 20c, particularly to the central part in the long side direction Y (winding axis WL direction) so that the central part of the negative electrode active material layer 24a has the half width ratio described above. In a preferred embodiment, this step includes a pressurizing step (step 2-A) and a depressurizing step (step 2-B). However, the depressurizing step (step 2-B) is optional and can be omitted in another embodiment. In addition, the order of the pressurizing step (step 2-A) and the depressurizing step (step 2-B) is not limited in particular; the depressurizing step (step 2-B) may be performed before the pressurizing step (step 2-A) or the depressurizing step (step 2-B) may be performed after the pressurizing step (step 2-A). Another step may further be included at an optional stage. This step may be performed in a normal temperature (about 25° C.±10° C.) environment.

In some embodiments, it is preferable to perform the pressurizing step (step 2-A) after a first standby time from the time when at least a part of the nonaqueous electrolyte solution is injected in the constructing step (specifically, the liquid injecting step). In other words, it is preferable to leave (keep) the battery assembly under the atmospheric pressure (normal pressure) for the first standby time after the completion of the liquid injection of at least a part of the nonaqueous electrolyte solution and before the start of the pressurizing step (step 2-A). More specifically, in the case where the predetermined amount of nonaqueous electrolyte solution is injected N times (N≥2) separately, for example, the pressurizing step (step 2-A) is preferably performed after the first standby time from the completion of the first liquid injection. On the other hand, in the case where the predetermined amount of nonaqueous electrolyte solution is injected entirely at one time, the pressurizing step (step 2-A) is preferably performed after the first standby time from the completion of the entire liquid injection at one time.

The first standby time is preferably 8 hours or more, more preferably 10 hours or more, still more preferably 12 hours or more, and particularly preferably 20 hours or more. In addition, the first standby time is preferably 40 hours or less, more preferably 35 hours or less, still more preferably 30 hours or less, and particularly preferably 25 hours or less. According to the present inventors' examination, the standby time is in correlation with the half width ratio of the negative electrode active material layer 24a. Therefore, setting the standby time within the aforementioned range makes it easy to adjust the half width ratio within the desired range (for example, 0.17 or less). In addition, the permeation of the nonaqueous electrolyte solution into the electrode bodies 20a, 20b, and 20c, particularly to the central part in the long side direction Y is promoted and the time required for the permeation can be shortened.

Furthermore, in the case where the predetermined amount of nonaqueous electrolyte solution is injected N times (N≥2) separately, the pressurizing step (step 2-A) is preferably performed after a second standby time from the entire injection of the predetermined amount of nonaqueous electrolyte solution by the completion of the N liquid injections. In other words, it is preferable to leave (keep) the battery assembly under the atmospheric pressure (normal pressure) for the second standby time after the completion of the injection of the entire amount of nonaqueous electrolyte solution and before the start of the pressurizing step (step 2-A).

The second standby time is preferably 4 hours or more, more preferably 6 hours or more, still more preferably 8 hours or more, and particularly preferably 16 hours or more. In addition, the second standby time is preferably 36 hours or less, more preferably 31 hours or less, still more preferably 26 hours or less, and particularly preferably 21 hours or less.

In the pressurizing step (step 2-A), the inside of the battery assembly is pressurized so that the pressure in the case 10 becomes higher than the atmospheric pressure (normal pressure). In one example, first, the battery assembly is accommodated in a chamber in which the pressure can be regulated, while the liquid injection hole 15 is opened (in other words, in a state where there is no difference in pressure inside and outside the case 10). Then, the inside of the chamber is pressurized until a predetermined pressurized state is obtained. Preferably, this pressurized state is kept for a predetermined time. The conditions of the pressurization, for example the attainment pressure (degree of pressurization) and the time to keep the pressurized state (pressurization keeping time), are preferably adjusted as appropriate in accordance with the length La of the negative electrode active material layer 24a in the long side direction Y, the standby time until the start of the pressurizing step described above, or the like.

For example, in the case where the length La of the negative electrode active material layer 24a in the long side direction Y is 200 mm or more (preferably, 250 mm or more), the pressurization is preferably performed until the pressure (degree of pressurization) in the case 10 becomes 0.4 MPa or more. The degree of pressurization is preferably 0.5 MPa or more, more preferably 0.6 MPa or more, and still more preferably 0.8 MPa or more. Thus, the permeation of the nonaqueous electrolyte solution into the electrode bodies 20a, 20b, and 20c, particularly to the central part in the long side direction Y is promoted suitably, making it easy to adjust the half width ratio of the negative electrode active material layer 24a within the desired range (for example, 0.17 or less). On the other hand, when the pressure becomes high to a certain degree, the permeation promoting effect will not become high anymore and at the same time, it will take time to increase the pressure; therefore, the degree of pressurization is preferably 2 MPa or less, more preferably 1.5 MPa or less, and still more preferably 1 MPa or less from the viewpoint of improving the working efficiency or the productivity.

In addition, in some embodiments, the state in which the pressure in the case 10 is in the aforementioned degree of pressurization (for example, 0.4 MPa or more) is preferably kept for a predetermined time. The keeping time at the aforementioned degree of pressurization (pressurization keeping time) is preferably 10 minutes or more, more preferably 20 minutes or more, and still more preferably 30 minutes or more. Thus, the permeation of the nonaqueous electrolyte solution into the electrode bodies 20a, 20b, and 20c, particularly to the central part in the long side direction Y is promoted suitably, making it easy to adjust the half width ratio of the negative electrode active material layer 24a within the desired range (for example, 0.17 or less). The pressurization keeping time is preferably 5 hours or less, more preferably 2 hours or less, and still more preferably 1 hour or less (for example, 30 minutes to 1 hour) from the viewpoint of improving the working efficiency or the productivity.

Note that “the pressurization keeping time” described here means the continuously keeping time typically. That is to say, in this step, the pressurization state is preferably kept continuously for 20 minutes or more, and more preferably kept continuously for 30 minutes or more. However, an aspect in which the pressure is reduced to less than 0.4 MPa in the middle for a very short time (for example, several seconds to one minute or less) is also allowed.

The pressurization is performed in a state in which the liquid surface of the surplus electrolyte solution injected in the liquid injecting step (step 1-4) exists preferably above a lower end of the electrode bodies 20a, 20b, and 20c and more preferably above a lower end of the flat part 20f. This makes it easy for the nonaqueous electrolyte solution to flow into the electrode bodies 20a, 20b, and 20c, so that the permeation of the nonaqueous electrolyte solution can be promoted. In addition, the pressurization is performed in a state in which the liquid surface of the surplus electrolyte solution exists preferably below an upper end of the electrode bodies 20a, 20b, and 20c and more preferably below an upper end of the positive electrode tab group 23 and an upper end of the negative electrode tab group 25. Thus, the air substituted with the nonaqueous electrolyte solution is exhausted easily and the permeation of the nonaqueous electrolyte solution can be promoted at a higher level.

In some embodiments, the pressurizing operation of increasing the pressure to the predetermined degree of pressurization in the pressurizing step is preferably performed only once. In other words, it is preferable that the pressurizing operation be not repeated a plurality of times. Thus, the time required for the pressurization can be shortened and the productivity or the working efficiency can be improved. In another embodiment, however, the pressurizing operation may be repeated twice or more with the depressurization performed therebetween, for example.

In some embodiments, the required time for the entire pressurizing step (step 2-A) is preferably shorter than the standby time until the start of the pressurizing step described above (the first standby time and/or the second standby time), although there is no particular limitation. In one example, the required time is preferably 5 hours or less, more preferably 2 hours or less, and still more preferably 1 hour or less (for example, 30 minutes to 1 hour).

In the depressurizing step (step 2-B), the inside of the case 10 is depressurized until the pressure in the case 10 becomes lower than the atmospheric pressure (normal pressure) before or after the pressurizing step. By reducing the pressure in the case 10, for example, the residual air remaining in the electrode bodies 20a, 20b, and 20c can be exhausted suitably, making it possible to promote the permeation of the nonaqueous electrolyte solution more. In the case where the length La of the negative electrode active material layer 24a in the long side direction Y is 200 mm or more (preferably, 250 mm or more), the pressure to be reduced (degree of depressurization) is preferably −55 kPa or less, more preferably −70 to −100 kPa, and still more preferably −80 to −90 kPa.

In some embodiments, it is preferable to keep the pressure in the case 10 at the aforementioned degree of depressurization for a predetermined time. The keeping time at the aforementioned degree of depressurization (depressurization keeping time) is preferably shorter than the aforementioned pressurization keeping time. The depressurization keeping time is preferably 1 minute or more, for example 1 to 10 minutes. Moreover, in some embodiments, the depressurizing operation of reducing the pressure until a predetermined degree of depressurization in the depressurizing step is preferably performed only once. In other words, it is preferable that the depressurizing operation be not repeated a plurality of times.

Note that another standby time may be provided as necessary after the pressurizing step or the depressurizing step is completed and before the first charging step is started. In other words, the battery assembly may be further left (kept) in the atmospheric pressure (normal pressure) state for a third standby time after the pressurizing step (for example, the pressurization keeping time) or the depressurizing step (for example, the depressurization keeping time) ends and before the first charging step (step 3) is started. The required time for the entire permeating step (step 2) including the standby time is preferably about 10 to 50 hours and more preferably 30 to 48 hours based on the time when at least a part of the nonaqueous electrolyte solution is injected in the liquid injecting step (step 1-4) from the viewpoint of improving the working efficiency or the productivity, although there is no particular limitation.

In the first charging step (step 3), the battery assembly is charged at least once after the permeating step. By the first charging, the B element containing compound (for example, boron-based additive) in the nonaqueous electrolyte solution is electrically decomposed. Thus, the film (SEI film) including the boron element is formed on the surface of the negative electrode active material layer 24a. Specifically, the film (SEI film) including the decomposition product of the B element containing compound is formed on the surface of the negative electrode active material layer 24a. Note that this step is performed under the atmospheric pressure (with the pressure neither increased nor decreased) after the battery assembly is returned to the atmospheric pressure (normal pressure) state, typically.

The battery assembly can be charged similarly to the conventional charging. Typically, an external power source is connected between the positive electrode terminal 30 and the negative electrode terminal 40 of the battery assembly, and charging is performed until the voltage between the terminals becomes a predetermined attainment voltage. In the case where the nonaqueous electrolyte solution includes the boron-based additive, charging is preferably performed until at least the decomposing potential of the boron-based additive. The battery assembly is charged until the state of charge (SOC) becomes preferably 5% or more and more preferably 10% or more. The state of charge (SOC) of the battery assembly in this step is preferably 50% or less, more preferably 40% or less, and still more preferably 30% or less. The charging rate may be, for example, about 0.1 to 2 C. For example, the charging may be performed once, or twice or more with the discharging conducted between the charging processes. This step may be performed in the normal temperature (for example, about 25° C.±10° C., 25° C.±5° C.) environment, or in a high temperature environment of about 45° C., for example. By charging in the high temperature environment, the film formation can be promoted.

In some embodiments, after the first charging step, the gas in the case 10, for example air, gas generated by the decomposition of the nonaqueous electrolyte solution in the first charging step, and the like are preferably discharged to the outside of the case 10. The gas can be discharged by, for example, depressurizing the inside of the case 10. Then, the liquid injection hole 15 is sealed with the sealing member 16 after the gas inside the case 10 is discharged. Thus, the case 10 is hermetically sealed (closed).

In the aging step (step 4), the battery assembly after the first charging is kept for a predetermined aging period under a predetermined temperature environment. The temperature environment is preferably 15 to 40° C. and may be normal temperature (about 25° C.±10° C.), for example. The aging period can vary depending on, for example, the length La of the negative electrode active material layer 24a in the long side direction Y, the conditions in the permeating step (step 2), and the like, and is preferably about five days or more and more preferably six days or more (for example, six to ten days). In this step, the voltage adjusted in the first charging step may be kept. The battery 100 can be manufactured suitably as above.

### <Application of Battery 100>

The battery 100 is usable in various applications, and can be suitably used as a motive power source for a motor (power source for driving) that is mounted in a vehicle such as a passenger car or a truck because of having the high capacity and the excellent thermal stability, for example. The vehicle is not limited to a particular type, and may be, for example, a plug-in hybrid electric vehicle (PHEV), a hybrid electric vehicle (HEV), or a battery electric vehicle (BEV). The battery 100 can also be suitably used as a battery pack in which the plurality of batteries 100 are arranged in a predetermined arrangement direction and a load is applied from the arrangement direction by a restriction mechanism.

Several Examples relating to the present disclosure will be explained below, but the present disclosure is not meant to be limited to these Examples.

### <Manufacture of Battery for Evaluation>

In the constructing step (step 1), battery assemblies with the same structure (Examples 1 to 3, and Comparative Examples 1 to 3) were constructed. Specifically, first, a lithium nickel cobalt manganese complex oxide (LiNi_{0.6}Co_{0.2}Mn_{0.2}O₂, NCM) was prepared as the positive electrode active material. Then, a positive electrode sheet with a band shape including, on an aluminum foil as the positive electrode current collector, the positive electrode active material layer including this positive electrode active material, a carbon material (AB) as the conductive material, and PVdF as the binder in a mass ratio of NCM:AB:PVdF=97.5:1.5:1.0 was manufactured. In addition, a negative electrode sheet with a band shape including, on a copper foil as the negative electrode current collector, the negative electrode active material layer including graphite (C) as the negative electrode active material, and SBR and CMC as the binder in a mass ratio of C:(SBR+CMC)=98.5:1.5 was manufactured.

Next, the positive electrode sheet and the negative electrode sheet that were manufactured as above were disposed to face each other through a separator sheet and wound in a flat shape; thus, a wound electrode body (the number of winding turns: 30 turns) was manufactured. Note that as the separator sheet, a separator sheet including a heat resistance layer (also functioning as an adhesive layer) including alumina and PVdF on a surface of a base material part made of PE was used. In addition, the length La of the negative electrode active material layer in the long side direction (winding axis direction) was 286 mm and the height Ha was 90 mm.

Next, the nonaqueous electrolyte solution was prepared in a manner that LiPF₆ was dissolved in a mixed solvent in which EC, EMC, and DMC were mixed, and LiBOB was added thereto as the additive so as to have a concentration of 0.05 mol/L. Then, the wound electrode body manufactured as above and the predetermined amount of nonaqueous electrolyte solution were accommodated in the case with a cuboid shape and thus, the battery assembly was constructed.

The predetermined amount of nonaqueous electrolyte solution was injected twice separately. Specifically, 238 g, which corresponded to about 58% of the entire amount (411 g), was injected in the first liquid injection, this state was left for four hours under the atmospheric pressure, and then 173 g, which corresponded to about 42% of the entire amount (411 g), was injected in the second liquid injection.

In the permeating step (step 2), the nonaqueous electrolyte solution permeated into the wound electrode body so that the half width ratio varied. Here, as shown in Table 1, the standby time (the first standby time) after the completion of the first liquid injection in the constructing step and before the start of the pressurizing step was changed in Examples 1 to 3 and Comparative Examples 2 and 3. Note that Table 1 also shows the standby time (the second standby time=the first standby time-four hours) after the completion of the second liquid injection and before the start of the pressurizing step.

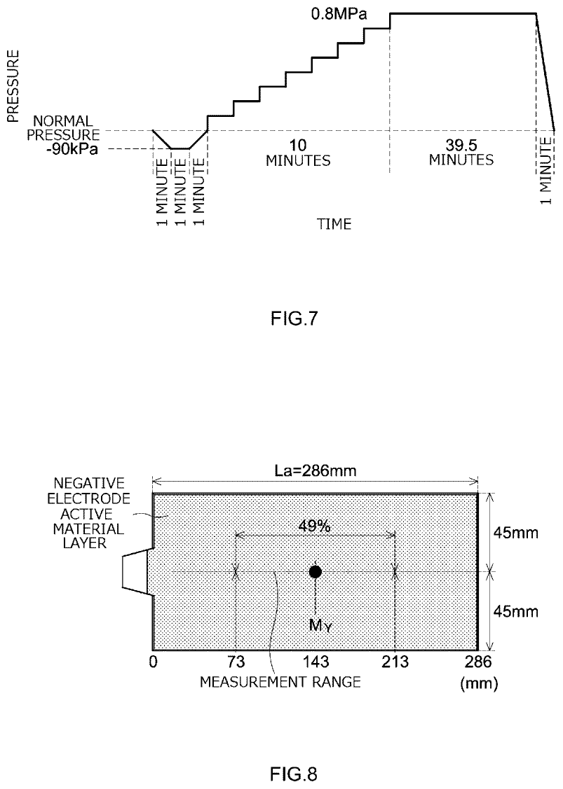

In each example, after the elapse of the standby time, the battery assembly was accommodated in the chamber in which the pressure can be regulated while the liquid injection hole was kept open and then, the pressurizing step and the depressurizing step were performed in this order in accordance with a pattern shown in FIG. 7. Specifically, the depressurizing step of reducing the pressure in the case to −90 kPa in one minute and keeping the depressurized state of −90 kPa for one minute was performed, the pressure was returned to the atmospheric pressure (normal pressure) in one minute, and then, the pressurizing step of gradually (stepwise) increasing the pressure in the case to 0.8 MPa in ten minutes at a rate of 0.1 MPa/1 minute and 15 seconds and keeping the pressurized state of 0.8 MPa for 39.5 minutes was performed. Subsequently, the pressure in the case was restored in one minute so as to be returned to the atmospheric pressure. Each of the depressurizing step and the pressurizing step was performed once. Note that in Comparative Example 1, the permeating step (depressurizing step and pressurizing step) was not performed and the battery assembly was left (kept) in the atmospheric pressure (normal pressure) state.

Next, the permeation status of the nonaqueous electrolyte solution in the wound electrode body was checked using X-ray CT. Although the detailed results are not shown here, the permeation status of the nonaqueous electrolyte solution can be grasped because the tone of color is different between the places where the nonaqueous electrolyte solution permeated and did not permeate in an X-ray transmission image. In Examples 1 to 3 and Comparative Examples 2 and 3, the battery assembly after the depressurizing step was observed at predetermined time intervals. In Comparative Example 1, since the permeating step was not performed, the battery assembly was observed at predetermined time intervals after the completion of the second liquid injection. Then, the time it took for the nonaqueous electrolyte solution to permeate to the central part of the wound electrode body was checked. The results are shown in Table 1. Note that Table 1 shows the required time using the completion of the first liquid injection as a start point.

As shown in Table 1, the permeation took the longest time in Comparative Example 1 in which the permeating step was not performed. In contrast to this, the time required for the permeation was relatively shortened in Examples 1 to 3 and Comparative Examples 2 and 3 including the permeating step. In particular, the time required for the permeation was shorter in Examples 1 to 3 in which the first standby time was 10 to 29 hours (in other words, the second standby time was 6 to 25 hours).

In the first charging step (step 3), the battery assembly was charged at a charging rate of 0.2 C to an SOC of 12% in a temperature environment of 25° C. in each example. Next, the pressure in the case was reduced to −90 kPa and the liquid injection hole was sealed with the sealing member with the pressure in the case 10 reduced. Next, in the aging step (step 4), the battery assembly after the first charging was kept for six days in the temperature environment of 25° C. In this manner, the batteries for evaluation (Examples 1 to 3 and Comparative Examples 1 to 3) were manufactured.

TABLE 1

| | | | | Half | The |
|---|---|---|---|---|---|
| | | | Permea- | width | amount |
| | | | tion | (mm) | of heat |
| | First | Second | comple- | (half | generation |
| | standby | standby | tion | width | (J) |
| | time | time | time | ratio | (relative |
| | (h) | (h) | (h)* | Lh/La) | value) |
| Comparative | — (No permeating step) | | 82.4 | 69.70 mm | 4.18 J |
| Example 1 | | | | (0.24) | (1.00) |
| Comparative | 6 | 2 | 62.7 | 46.22 mm | 4.25 J |
| Example 2 | | | | (0.25) | (1.02) |
| Example 1 | 10 | 6 | 21.6 | 46.22 mm | 3.16 J |
| | | | | (0.16) | (0.76) |
| Example 2 | 24 | 20 | 26.5 | 35.99 mm | 2.71 J |
| | | | | (0.13) | (0.65) |
| Example 3 | 29 | 25 | 32.0 | 41.67 mm | 2.96 J |
| | | | | (0.15) | (0.71) |
| Comparative | 45 | 41 | 47.0 | 56.45 mm | 3.60 J |
| Example 3 | | | | (0.20) | (0.86) |

*Required time after the completion of the first liquid injection

<Preparation of measurement sample> The battery for evaluation after the aging was discharged until the voltage became 3.0 V and disassembled in a dry air atmosphere (for example, with a dew point of about −50° C.), and then, the wound electrode body was extracted from the case. After that, the winding of the wound electrode body was unfastened to separate the negative electrode. Then, the negative electrode was cut out into the suitable size along the long side direction and cleaned with DMC; thus, a measurement sample was obtained. Note that the cutting position was the flat part existing at the 17th turn (intermediate periphery) from a winding start end part. FIG. 8 is a schematic view of the measurement sample.

<Calculation of half width ratio> First, the central part of the negative electrode active material layer of the measurement sample was irradiated with laser along the winding axis direction (long side direction) using LA-ICP-MS, and ICP mass spectrometry was performed continuously while the laser irradiated part of the sample was made into microparticles. For each point, the ratio (B/C) of the amount of boron (B) element to the amount of carbon (C) element was obtained. Note that, as illustrated in FIG. 8, the measurement range included the center of the flat part of the negative electrode active material layer (center in the short side direction and center in the long side direction) and covered 49% of the length La (286 mm) of the entire negative electrode active material layer in the winding axis direction. Specifically, the measurement range was the range of ±70 mm from the center My (at a position 143 mm) of the negative electrode active material layer in the winding axis direction (that is, the range of 73 to 213 mm in FIG. 8, 140 mm in total).

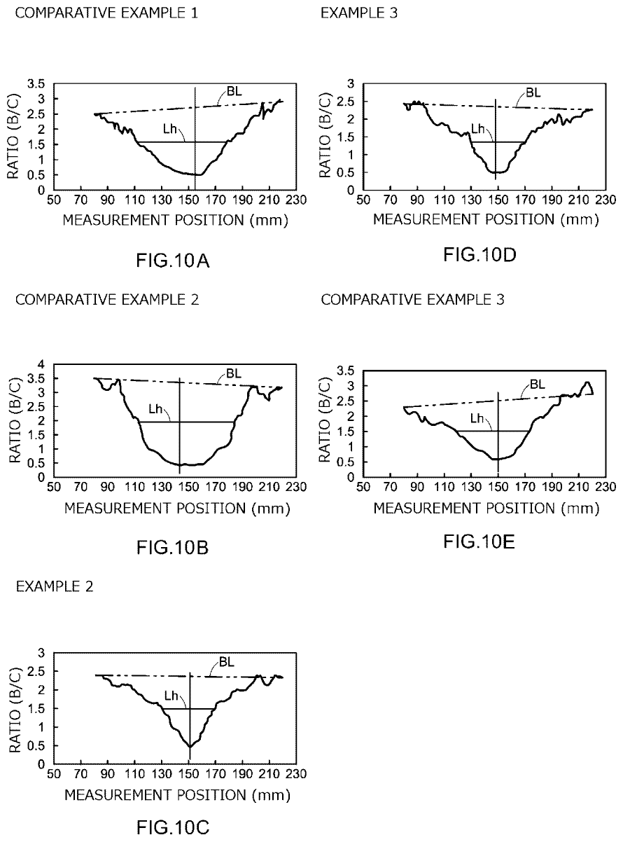

Next, a graph showing the distribution of the ratio (B/C), specifically a graph showing the measurement position (mm) in the winding axis direction along the horizontal axis and the ratio (B/C, no unit) along the vertical axis was created (procedure 1). FIG. 9 is a graph showing the distribution of the ratio (B/C) according to Example 1. In addition, FIG. 10A is a graph showing the distribution of the ratio (B/C) according to Comparative Example 1, FIG. 10B is a graph showing the distribution of the ratio (B/C) according to Comparative Example 2, FIG. 10C is a graph showing the distribution of the ratio (B/C) according to Example 2, FIG. 10D is a graph showing the distribution of the ratio (B/C) according to Example 3, and FIG. 10E is a graph showing the distribution of the ratio (B/C) according to Comparative Example 3.

As shown in FIG. 9 and FIG. 10A to FIG. 10E, each graph represents a shape that projects downward and the ratio (B/C) is smaller toward the central part in the winding axis direction, that is, the amount of boron is smaller.

Next, the half width Lh (mm) was obtained (procedure 2). For instance, in Example 1, a base line BL connecting both ends (E1 and E2 in FIG. 9) of the measurement range (the central part of the negative electrode active material layer 24a) in the winding axis direction was first drawn as illustrated in FIG. 9. Next, a straight line was drawn to the base line BL along the vertical axis from a peak position P1 at which the value of the ratio (B/C) was the minimum. Subsequently, an intersection P2 between this straight line and the base line BL was obtained and a difference (|P2−P1|) between the intersection P2 and the peak position P1 was defined as the width W. Then, the half width Lh (mm) along the horizontal axis was measured at a position where the width W becomes a half (½W). The results are shown in Table 1.

Then, the half width Lh (mm) obtained as above was divided by the length La (286 mm) of the negative electrode active material layer 24a in the winding axis WL direction, so that the half width ratio (Lh/La) was obtained (procedure 3). Note that, although the procedure in Example 1 has been described in detail here as one example, the half with ratio (Lh/La) was obtained similarly about other examples (Examples 2 and 3 and Comparative Examples 1 and 2). The results are shown in Table 1.

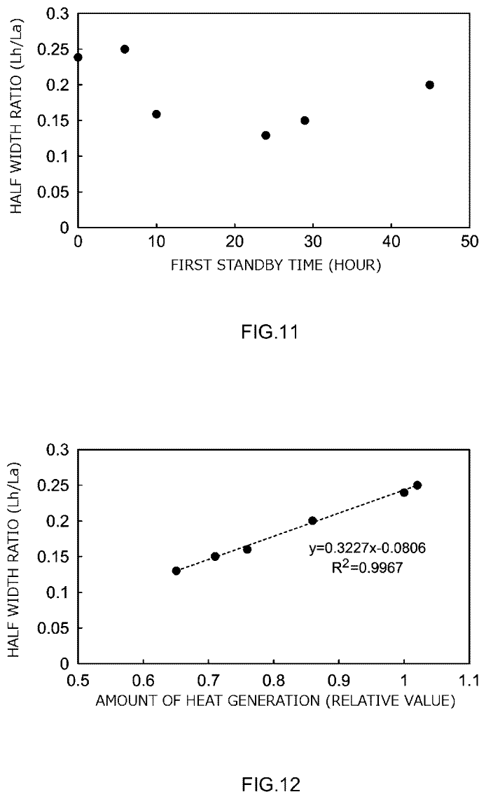

FIG. 11 is a graph showing a relation between the first standby time (time) and the half width ratio (Lh/La). As shown in FIG. 11 and Table 1, it is acknowledged that the half width ratio is correlated with the standby time here. Specifically, it is acknowledged that the half width ratio tends to become smaller as the first standby time becomes longer until the first standby time becomes about 10 hours. On the other hand, if the first standby time exceeds about 30 hours, it is acknowledged that the half width ratio tends to become larger as the first standby time becomes longer. Thus, it is understood that the half width ratio is suppressed to be small when the first standby time is 10 to 30 hours.

<Evaluation of the amount of heat generation of negative electrode> First, a sample for differential scanning calorimetry (DSC) measurement was manufactured for each example. Specifically, first, the battery in which the processes up to the activating process (aging step) were completed was disassembled in an Ar atmosphere in accordance with the aforementioned <manufacture of battery for evaluation> and the positive electrode including the positive electrode active material layer (20 mm×20 mm square) and the negative electrode including the negative electrode active material layer (22 mm×22 mm square) were cut out from the central position of an electrode plate (17th turn) illustrated in FIG. 8. Next, the positive electrode and the negative electrode that were cut out were disposed to face each other through the separator and accommodated together with 0.4 mL of the nonaqueous electrolyte solution in the dry air (dew point: −50° C.) atmosphere; thus, a laminate cell was constructed. Next, the laminate cell was charged with constant current up to 4.25 V with a current value of 8 mA and then charged with constant voltage for five hours.

Subsequently, the charged laminate cell was disassembled in a glove box (Ar atmosphere). Next, the electrolyte solution was extracted and additionally the positive electrode and the negative electrode were extracted, and then a positive electrode mixture was peeled from a central region of the positive electrode active material layer and a negative electrode mixture was peeled from a central region of the negative electrode active material layer. Subsequently, 1 mg of the positive electrode mixture peeled from the positive electrode, 2 mg of the negative electrode mixture peeled from the negative electrode, and 4 mg of the extracted electrolyte solution were accommodated in a sample container. This sample container was sealed by pressing at 20 MPa, and then set to DSC together with a standard material (Al₂O₃, 2 mg). Subsequently, the temperature was increased at a temperature increasing rate of 2° C./min from 25° C. to 350° C. under an inert atmosphere and the amount of heat generation (J) between 75 and 200° C. was obtained by integration. The results are shown in Table 1. Note that Table 1 also shows the relative value based on the amount of heat generation (1.00) in Comparative Example 1 in which the permeating step was not performed.

FIG. 12 is a graph showing a relation between the half width ratio (Lh/La) and the amount of heat generation of the negative electrode (relative value). As shown in FIG. 12 and Table 1, the correlation was observed between the half width ratio and the amount of heat generation. That is to say, the amount of heat generation was suppressed as the half width ratio became smaller. For example, when the half width ratio is 0.17 or less, the amount of heat generation can be suppressed to about 80% of that in Comparative Example 1 and it is understood that the thermal stability of the battery can be improved. The above results indicate the significance of the art disclosed herein.

Although some embodiments of the present disclosure have been described above, these embodiments are just examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

As described above, the following items are given as specific aspects of the art disclosed herein.
Item 1: The electrical energy storage device including the wound electrode body in which the positive electrode with a band shape and the negative electrode with a band shape are stacked and wound in the insulated state, the nonaqueous electrolyte solution, and the case that accommodates the wound electrode body and the nonaqueous electrolyte solution, in which the negative electrode includes the negative electrode active material layer containing the carbon material and having a length of 200 mm or more in the winding axis direction, the negative electrode active material layer includes the film containing the boron element, and the ratio (B/C) of the boron element to the carbon element is obtained along the winding axis direction in accordance with the laser ablation ICP mass spectrometry at the central part of the negative electrode active material layer in the winding axis direction and the half width ratio calculated by the following procedures is 0.17 or less: (procedure 1) the graph showing the measurement position in the winding axis direction along the horizontal axis and the ratio (B/C) along the vertical axis is created; (procedure 2) the base line connecting both ends of the central part in the winding axis direction is drawn, and based on the width of the straight line extended along the vertical axis to the base line from the peak position at which the value of the ratio (B/C) is the minimum, the half width is measured at the position where the width of the straight line becomes a half; and (procedure 3) the half width is divided by the length of the negative electrode active material layer in the winding axis direction.
Item 2: The electrical energy storage device according to Item 1, in which the nonaqueous electrolyte solution includes the compound containing the boron element.
Item 3: The manufacturing method for the electrical energy storage device including the wound electrode body in which the positive electrode with a band shape and the negative electrode with a band shape are stacked and wound in the insulated state, the nonaqueous electrolyte solution, and the case that accommodates the wound electrode body and the nonaqueous electrolyte solution, in which the negative electrode includes the negative electrode active material layer containing the carbon material and having a length of 200 mm or more in the winding axis direction, the negative electrode active material layer includes the film containing the boron element, and the ratio (B/C) of the boron element to the carbon element is obtained along the winding axis direction in accordance with the laser ablation ICP mass spectrometry at the central part of the negative electrode active material layer in the winding axis direction and the half width ratio calculated by the following procedures is 0.17 or less: (procedure 1) the graph showing the measurement position in the winding axis direction along the horizontal axis and the ratio (B/C) along the vertical axis is created; (procedure 2) the base line connecting both ends of the central part in the winding axis direction is drawn, and based on the width of the straight line extended along the vertical axis to the base line from the peak position at which the value of the ratio (B/C) is the minimum, the half width is measured at the position where the width of the straight line becomes a half; and (procedure 3) the half width is divided by the length of the negative electrode active material layer in the winding axis direction, the manufacturing method including: the constructing step for the battery assembly, in which the wound electrode body is accommodated in the case and the nonaqueous electrolyte solution including the compound containing the boron element is injected; the permeating step of pressurizing at least the inside of the case after the constructing step, thereby making the nonaqueous electrolyte solution permeate into the wound electrode body so that the aforementioned half width ratio is obtained; and the first charging step of charging the battery assembly at least once after the permeating step.
Item 4: The manufacturing method according to Item 3, in which in the permeating step, the pressurization is performed after 10 to 30 hours from the injection of at least a part of the nonaqueous electrolyte solution in the constructing step.
Item 5: The manufacturing method according to Item 4, in which in the permeating step, the pressurization is performed until the pressure in the case becomes 0.4 MPa or more and the state in which the pressure in the case is 0.4 MPa or more is kept for 20 minutes or more.
Item 6: The manufacturing method according to Item 4 or 5, in which in the permeating step, the inside of the case is depressurized until the pressure in the case becomes lower than the atmospheric pressure before or after the pressurization.
Item 7: The manufacturing method according to any one of Items 3 to 6, in which in the constructing step, the predetermined amount of the nonaqueous electrolyte solution is injected N times (N≥2) separately, and 50±10% of the predetermined amount is injected in the first liquid injection and after three hours or more from the first liquid injection, the second liquid injection is performed.
Item 8: The manufacturing method according to any one of Items 3 to 7, in which in the permeating step, the pressurization is performed after 6 to 26 hours from the entire injection of the predetermined amount of the nonaqueous electrolyte solution by the N liquid injections.

What is claimed is:

1. An electrical energy storage device comprising a wound electrode body in which a positive electrode with a band shape and a negative electrode with a band shape are stacked and wound in an insulated state, a nonaqueous electrolyte solution, and a case that accommodates the wound electrode body and the nonaqueous electrolyte solution, wherein
the negative electrode includes a negative electrode active material layer containing a carbon material and having a length of 200 mm or more in a winding axis direction,
the negative electrode active material layer includes a film containing a boron element, and
a ratio (B/C) of the boron element to a carbon element is obtained along the winding axis direction in accordance with laser ablation ICP mass spectrometry at a central part of the negative electrode active material layer in the winding axis direction and a half width ratio calculated by the following procedures is 0.17 or less:
(procedure 1) a graph showing a measurement position in the winding axis direction along a horizontal axis and the ratio (B/C) along a vertical axis is created;
(procedure 2) a base line connecting both ends of the central part in the winding axis direction is drawn, and based on a width of a straight line extended along the vertical axis to the base line from a peak position at which a value of the ratio (B/C) is the minimum, a half width is measured at a position where the width of the straight line becomes a half; and
(procedure 3) the half width is divided by a length of the negative electrode active material layer in the winding axis direction.

2. The electrical energy storage device according to claim 1, wherein the nonaqueous electrolyte solution includes a compound containing the boron element.

3. A manufacturing method for an electrical energy storage device including a wound electrode body in which a positive electrode with a band shape and a negative electrode with a band shape are stacked and wound in an insulated state, a nonaqueous electrolyte solution, and a case that accommodates the wound electrode body and the nonaqueous electrolyte solution, wherein
the negative electrode includes a negative electrode active material layer containing a carbon material and having a length of 200 mm or more in a winding axis direction,
the negative electrode active material layer includes a film containing a boron element, and
a ratio (B/C) of the boron element to a carbon element is obtained along the winding axis direction in accordance with laser ablation ICP mass spectrometry at a central part of the negative electrode active material layer in the winding axis direction and a half width ratio calculated by the following procedures is 0.17 or less:
(procedure 1) a graph showing a measurement position in the winding axis direction along a horizontal axis and the ratio (B/C) along a vertical axis is created;
(procedure 2) a base line connecting both ends of the central part in the winding axis direction is drawn, and based on a width of a straight line extended along the vertical axis to the base line from a peak position at which a value of the ratio (B/C) is the minimum, a half width is measured at a position where the width of the straight line becomes a half; and
(procedure 3) the half width is divided by a length of the negative electrode active material layer in the winding axis direction, the manufacturing method comprising:
a constructing step for a battery assembly, in which the wound electrode body is accommodated in the case and the nonaqueous electrolyte solution including a compound containing the boron element is injected;
a permeating step of pressurizing at least an inside of the case after the constructing step, thereby making the nonaqueous electrolyte solution permeate into the wound electrode body so that the aforementioned half width ratio is obtained; and
a first charging step of charging the battery assembly at least once after the permeating step.

4. The manufacturing method according to claim 3, wherein in the permeating step, the pressurization is performed after 10 to 30 hours from injection of at least a part of the nonaqueous electrolyte solution in the constructing step.

5. The manufacturing method according to claim 4, wherein in the permeating step, the pressurization is performed until a pressure in the case becomes 0.4 MPa or more and a state in which the pressure in the case is 0.4 MPa or more is kept for 20 minutes or more.

6. The manufacturing method according to claim 4, wherein in the permeating step, the inside of the case is depressurized until the pressure in the case becomes lower than an atmospheric pressure before or after the pressurization.

7. The manufacturing method according to claim 3, wherein
in the constructing step, a predetermined amount of the nonaqueous electrolyte solution is injected N times (N≥2) separately, and
50±10% of the predetermined amount is injected in a first liquid injection and after three hours or more from the first liquid injection, a second liquid injection is performed.

8. The manufacturing method according to claim 7, wherein in the permeating step, the pressurization is performed after 6 to 26 hours from the entire injection of the predetermined amount of the nonaqueous electrolyte solution by the N liquid injections.
